(19) United States
(12) Patent Application Publication
(10) Pub. No.: US 2007/0135163 A1
(43) Pub. Date: Jun. 14, 2007

(54) Wireless earphone with retractable microphone

(76) Inventor: Tung-Yuan Lee, GuiShan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/298,465

(22) Filed: Dec. 12, 2005

(51) Int. Cl. H04B 1/38

(52) U.S. Cl. 455/557

(57) ABSTRACT

A wireless earphone includes a speaker, a circuit unit, a lower and an upper case enclosing the speaker and the circuit unit between them, a guiding unit mounted on a top of the upper case, and a sliding unit movably mounted on the guiding unit. The sliding unit is provided with a microphone. When a push button on a top of the sliding unit is depressed, the sliding unit automatically slides along the guiding unit to project from a front end of the upper case and actuates the communication system of the earphone. When the sliding unit retracts to the position on the top of the upper case, the communication is disconnected.

### BACKGROUND OF THE INVENTION

1. Field of the Invention

The present invention relates to a wireless earphone, and more particularly to a wireless earphone with a retractable microphone to upgrade the sensitivity of the microphone in receiving sound.

2. Description of the Prior Art

Earphones and microphones are frequently used in stereophonic and communication systems. Conventional earphones/microphones have different forms for wearing over a user's head, hanging on a user's ear, or plugging in a user's ear. The earphone/microphone for wearing over the user's head is most frequently seen in home stereos, and usually provides better sound spectrum. The plug-type earphone/microphone is often used with a hand-free receiver for a mobile phone or a walkman. With the advancement in technologies, earphones have developed from the conventional wired types to the wireless types. Currently very popular wireless earphones include infrared earphones, radio frequency (RF) earphones, and Bluetooth earphones. However, Bluetooth earphone is the first duplex wireless earphone available in the market.

The currently available Bluetooth earphone has unique and miniaturized design. As a result, the microphone included in the earphone is located at a point somewhat distant from the user's mouth. In this case, the microphone must be toned to have a high sensitivity in receiving sound. However, the microphone would also receive more noises at the same time, and requires more complicate circuits to enhance the sound receiving sensitivity thereof, resulting in higher manufacturing cost and selling price of the Bluetooth earphone.

It is therefore tried by the inventor to develop a wireless earphone with retractable microphone particularly suitable for use on a Bluetooth mobile phone with music playing function. In the wireless earphone, a push button is provided on a sliding unit mounted on a top of an upper case of the earphone, so that the sliding unit and a microphone provided thereon are automatically slid to project from a front end of the upper case of the earphone to actuate voice communication and receive sound with high sensitivity over the earphone when the push button is depressed; and when the sliding unit with the microphone is retracted, the voice communication automatically disconnects.

### SUMMARY OF THE INVENTION

A primary object of the present invention is to provide a wireless earphone with a retractable microphone, which automatically slides to project from a front end of the earphone to actuate the voice communication when a push button is depressed, and disconnects the voice communication when it is moved to a retracted position.

Another object of the present invention is to provide a wireless earphone with a retractable microphone, so that the earphone can be conveniently carried and stored with the microphone normally located in the retracted position.

A further object of the present invention is to provide a wireless earphone with a retractable microphone, which is protected against breaking or damaging when a user carelessly drops the earphone when the same is in use.

To achieve the above and other objects, the wireless earphone of the present invention includes a sounding unit, a circuit unit, a lower case, an upper case, a guiding unit, and a sliding unit. The lower and the upper case are mutually connected to enclose the sounding unit and the circuit unit therebetween. The upper case is provided at a top with a first recess for the guiding unit to mount therein. The sliding unit is mounted on the guiding unit to slidably move between a projected or actuating and a retracted or disconnecting position.

The guiding unit includes a pair of guiding shafts having elastic elements mounted thereon, and a sliding element slidably mounted on the guiding shafts in front of the elastic elements. The sliding element is provided at a lower front end with a first retaining recess and at a rear top with a second retaining recess, and at two lateral sides with an axially bored ear portion each. The guiding shafts are extended through the bored ear portions of the sliding element and then mounted in the first recess on the top of the upper case.

The sliding unit includes a seat, a circuit board, and a cover. The seat is provided with a first hook for hooking to the second retaining recess on the top of the sliding element, and has a first hole provided in front of the first hook for a second hook to mount therein and hook to the first retaining recess on the sliding element. The circuit board is mounted on the seat. The cover is connected to a top of the seat and is provided at a predetermined position with a button hole for a push button to mount therein.

The upper case of the earphone is provided with a second hole for a third hook to mount therein. The third hook has a lower end mounted with an elastic element to normally push the third hook upward, and an upper end in contact with the push button on the cover of the sliding unit.

When the push button on the cover of the sliding unit is depressed with a minor force, the third hook on the upper case is depressed, and the sliding unit is allowed to automatically slide along the guiding shafts of the guiding unit to a position projected from a front end of the upper case and actuates voice communication over the wireless earphone. When the sliding unit is retracted to the top of the upper case, the voice communication is disconnected. The sliding unit in the retracted position is protected from breaking or damage when the earphone in use is carelessly fallen.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a wireless earphone according to the present invention;

FIG. 2 is an assembled view of FIG. 1;

FIG. 3A is a sectional view taken along line A-A of FIG. 2;

FIGS. 3B and 3C are enlarged views of the circled areas of FIG. 3A;

FIG. 4 is a sectional view taken along line B-B of FIG. 2;

FIG. 5 is a perspective view showing a sliding unit included in the wireless earphone of the present invention is slid to a projected or actuating position for use;

FIG. 6A is a sectional view taken along line A-A of FIG. 5;

FIG. 6B is an enlarged view of the circled area of FIG. 6A;

FIG. 7 is a sectional view taken along line B-B of FIG. 5;

FIG. 8 is a perspective view showing the connecting of the sliding unit to an upper case of the wireless earphone of the present invention;

FIG. 9a is a sectional view taken on line A-A of FIG. 8;

FIG. 9B is an enlarged view of the circled area of FIG. 9A; and

FIG. 10 is a perspective view showing the disassembling of the sliding unit from the upper case of the wireless earphone of the present invention.

### DETAILED DESCRIPTION OF THE INVENTION

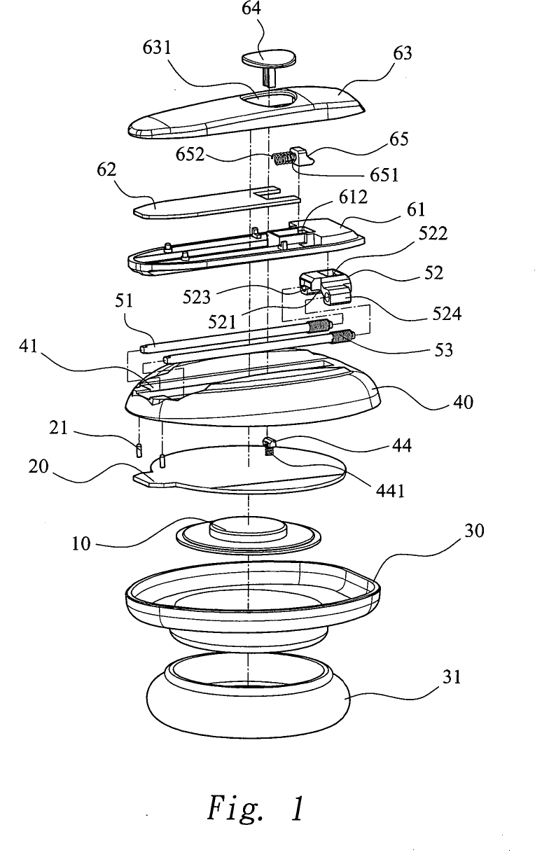

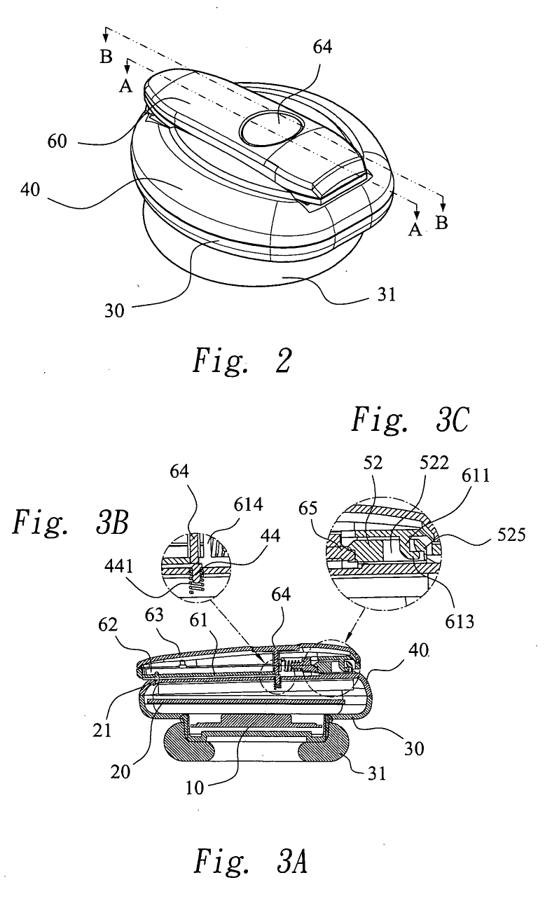

Please refer to FIGS. 1 and 2 that are exploded and assembled perspective views, respectively, of a wireless earphone with retractable microphone according to a preferred embodiment of the present invention. As shown, the wireless earphone includes a sounding unit 10, a circuit unit 20, a lower case 30, an upper case 40, a guiding unit 50, and a sliding unit 60. The sounding unit 10 and the circuit unit 20 are enclosed in a space defined between the mutually connected lower and upper cases 30, 40. The guiding unit 50 is mounted in a first recess 41 formed on a top of the upper case 40 for guiding the sliding unit 60 to slide between a position projected from a front end of the upper case 40 and a position retracted to a top of the upper case 40.

The sounding unit 10 may be, for example, a loudspeaker electrically connected to the circuit unit 20, so as to produce sounds, such as voice or music. The circuit unit 20 is a circuit board.

The lower case 30 may be covered with a protective casing 31 to protect the lower case 30 against dirt and damage. To allow sound to transmit through the lower case 30 from the sounding unit 10, the lower case 30 is provided with a plurality of small holes.

The circuit unit 20 has at least one terminal 21 upward projected from a terminal hole provided on the upper case 40, so that the terminal 21 is electrically connected to the sliding unit 60 that includes a microphone. The lower case 30 and the upper case 40 are mutually connected to enclose the sounding unit 10 and the circuit unit 20 in a space defined between the lower and upper cases 30, 40 to form an earphone.

The guiding unit 50 includes a pair of guiding shafts 51 and a sliding element 52. Each of the guiding shafts 51 has an elastic element 53 mounted thereon. The sliding element 52 is provided at a lower front end with a first retaining recess 521, and at a rear top with a second retaining recess 522. An ear 524 having an axial shaft hole 523 is sideward extended from each lateral side of the sliding element 52, so that the guiding shafts 51 may be extended through the shaft holes 523 of the sliding element 52 and then mounted in the first recess 41 on the top of the upper case 40. The sliding element 52 is mounted on the guiding shafts 51 in front of the elastic elements 53 to normally push the elastic elements 53 into a compressed state and can be elastically pushed forward by the compressed elastic elements 53.

The sliding unit 60 includes a seat 61, a circuit board 62, and a cover 63. The seat 61 has a first hook 611 (see FIG. 3C) hooked to the second retaining recess 522 on the top of the sliding element 52. The seat 61 is provided in front of the first hook 611 with a first hole 612. A second hook 65 is mounted in the first hole 612 of the seat 61 to hook to the first retaining recess 521 at the lower front end of the sliding element 52. The circuit board 62 is mounted on the seat 61, and enclosed in a space defined between the mutually connected seat 61 and cover 63. There is a sound receiving element, that is, a microphone provided on the circuit board 62. The cover 63 is provided at a predetermined position with a button hole 631, in which a push button 64 is mounted for downward pushing against a third hook 44. Preferably, when the sliding unit 60 is forward slid to project from the front end of the upper case 40, an electric terminal 621 on the circuit board 62 is in contact with and electrically connected to the terminal 21 of the circuit unit 20.

Preferably, the second hook 65 includes a front rod 651, on which an elastic element 652 is mounted. When the second hook 65 is mounted in the first hole 612 on the seat 61, the elastic element 652 normally elastically pushes the second hook 65 rearward against the first retaining recess 521 of the sliding element 52. When an external forward force is applied to the second hook 65 to elastically compress the elastic element 652, the second hook 65 is allowed to separate from the first retaining recess 521.

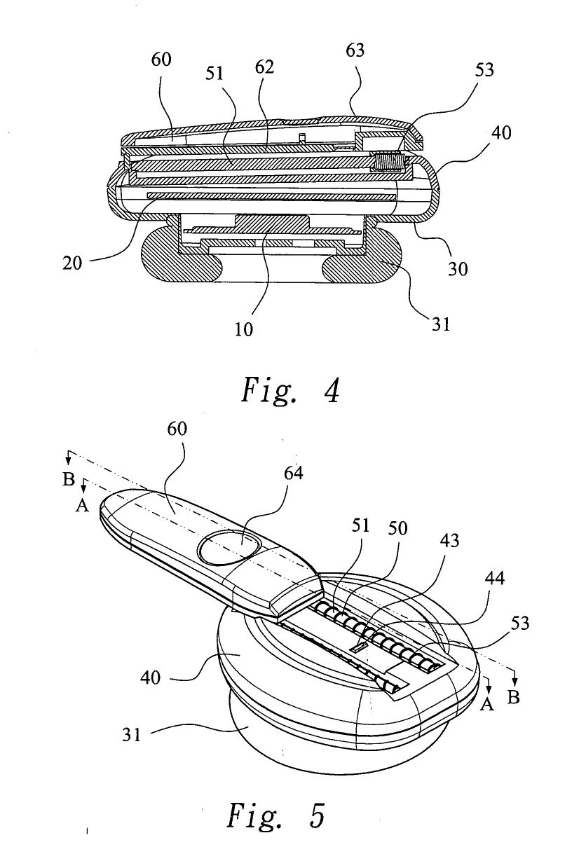

Preferably, the upper case 40 is provided at a predetermined position with a second hole 43 (see FIG. 5), in which the third hook 44 is mounted. The third hook 44 has an upper end in contact with the push button 64 of the sliding unit 60, and a lower end having an elastic element 441 mounted thereon. When the push button 64 is downward pushed, the third hook 44 is moved downward and the elastic element 441 is compressed, allowing the sliding unit 60 to disengage from the upper case 40 and be elastically pushed by the elastic elements 53 to slide forward along the guiding shafts 51.

Please refer to FIGS. 3A and 4 that are sectional views taken along line A-A and line B-B of FIG. 2, respectively, and to FIGS. 3B and 3C that are enlarged views of the circled areas of FIG. 3A.

FIG. 3A shows the sliding unit 60 is retained to the retracted position on the top of the upper case 40. FIG. 3B shows the third hook 44 is upward projected from the second hole 43 of the upper case 40 into a retaining section 614 of the seat 61, and the whole sliding unit 60 is retained to the top of the upper case 40. When the push button 64 is depressed, the third hook 44 is pushed to move downward and the elastic element 441 at the lower end of the third hook 44 is elastically compressed. At this point, the whole sliding unit 60 is allowed to separate from the upper case 40. FIG. 3C shows the second hook 65 is normally rearward pushed by the elastic element 652 to hook to the first retaining recess 521 of the sliding element 52, and the first hook 611 is hooked to the second retaining recess 522 on the rear top of the sliding element 52. The second retaining recess 522 includes an inner recess 525 adapted to engage with a hook end 613 of the first hook 611, so as to hold the cover 63 to the seat 61. FIG. 4 shows the elastic elements 53 are normally elastically compressed behind the sliding element 52 to store compression energy for pushing the sliding element 52 and accordingly the sliding unit 60 forward when the sliding unit 60 is released from the upper case 40 to move forward.

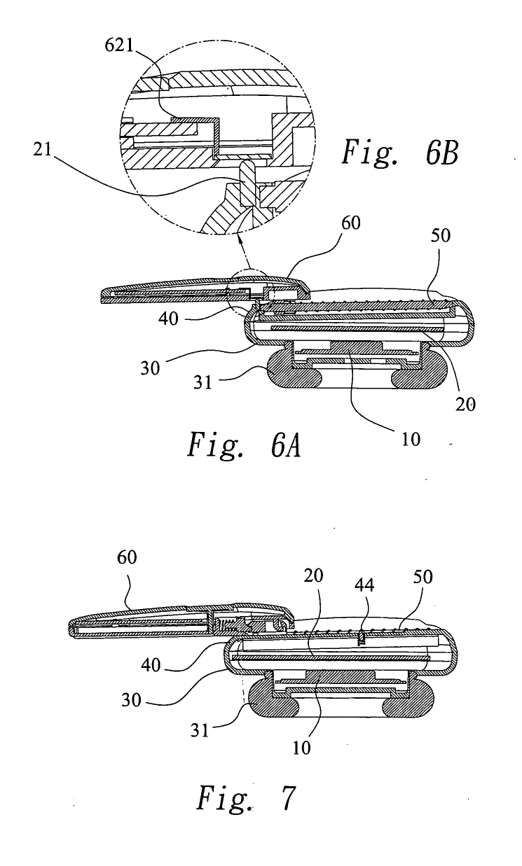

Please refer to FIG. 5 that shows the sliding unit 60 is pushed by the elastic elements 53 to slide along the guiding shafts 51 of the guiding unit 50 to project from the front end of the upper case 40 of the wireless earphone of the present invention, and to FIGS. 6A and 7, which are sectional views taken along line A-A and line B-B of FIG. 5, respectively. FIG. 6A shows the elastic elements 53 push the sliding unit 60 to slide along the guiding shafts 51 to project from the front end of the upper case 40. FIG. 6B is an enlarged view of the circled area of FIG. 6A showing the electric terminal 621 on the circuit board 62 is electrically connected to the terminal 21 on the circuit unit 20 when the sliding unit 60 is projected from the front end of the upper case 40. At this point, the microphone on the circuit board 62 is electrically connected to the earphone and powered, allowing the earphone to transmit and receive signals.

FIG. 7 shows that when the third hook 44 is downward pushed, the sliding unit 60 is immediately released from the upper case 40 and pushed by the elastic elements 53 to slide forward along the guiding shafts 51. That is, the microphone provided in the sliding unit 60 is extended from the earphone and electrically connected to the earphone.

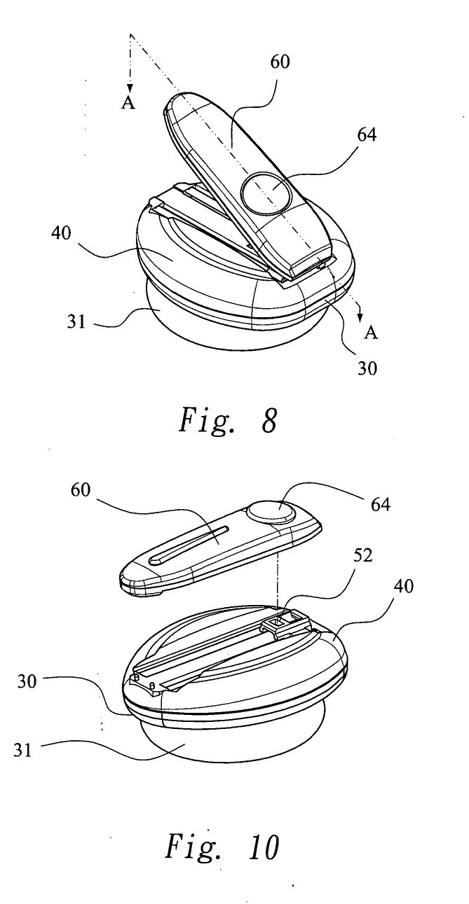

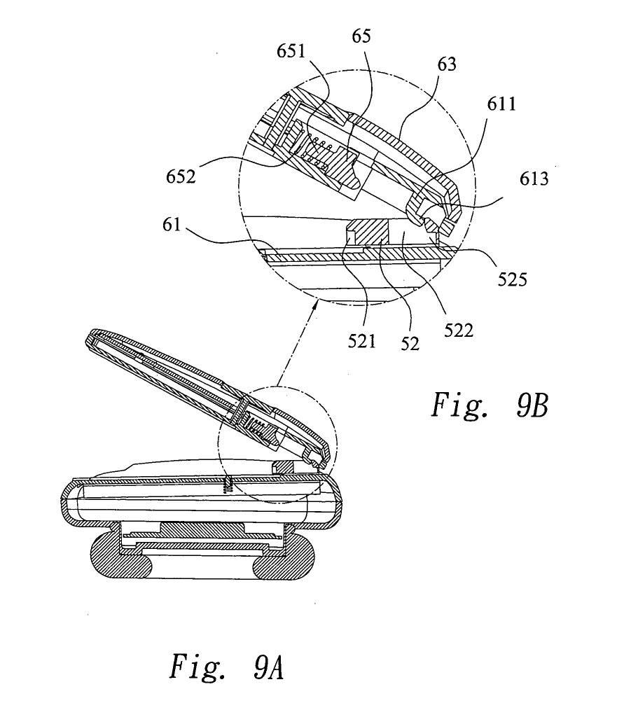

FIG. 8 is a perspective view showing the mounting of the sliding unit 60 to the top of the upper case 40 of the wireless earphone of the present invention, and FIG. 9A is a sectional view taken along line A-A of FIG. 8. Please also refer to FIG. 9B that is an enlarged view of the circled area of FIG. 9A. To connect the sliding unit 60 to the upper case 40, first engage the hook end 613 of the first hook 611 at the seat 61 of the sliding unit 60 with the inner recess 525 of the sliding element 52 and then downward press the cover 63, so that the second hook 65 is moved into the first retaining recess 521 of the sliding element 52 due to the elastic element 652 that normally pushes the sliding element 52 rearward into the first retaining recess 521. The sliding unit 60 connected to and located at the retracted position on the top of the upper case 40 is protected against breading or damage when the earphone in use is carelessly dropped. Even if the sliding unit 60 is separated from the upper case 40 when the wireless earphone is carelessly dropped, the sliding unit 60 may be reconnected to the upper case 40 in the above-described manner.

FIG. 10 is a perspective view showing the disassembling of the sliding unit 60 from the upper case 40 of the wireless earphone of the present invention. To do so, first release the second hook 65 from the first retaining recess 521 of the sliding element 52 by compressing the elastic element 652; and then separate the hook end 613 of the first hook 611 from the inner recess 525 of the sliding element 52, enabling the sliding unit 60 to separate from the sliding element 52.

With the above arrangements, the sliding unit 60 with the retractable microphone may be easily assembled to the wireless earphone of the present invention and operated. When the sliding unit 60 with the retractable microphone is in a retracted position, the wireless earphone can be conveniently carried or stored. When the push button 64 on the sliding unit 60 is depressed with a minor force, the whole sliding unit 60 is automatically extended from the front end of the upper case 40 of the wireless earphone to actuate a Bluetooth communication system. In the event the sliding unit 60 is separated from the upper case 40 of the wireless earphone due to careless dropping of the wireless earphone in use, it may be reconnected to the wireless earphone without breaking or damage.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A wireless earphone, comprising a sounding unit, a circuit unit, a lower case, an upper case, a guiding unit, and a sliding unit;
said upper case being connected to said lower case to enclose said sounding unit and said circuit unit in a space defined between said connected upper and lower cases, and provided at a top with a first recess for said guiding unit to mount therein; and
said sliding unit being movably mounted on said guiding unit.

2. The wireless earphone as claimed in claim 1, wherein said sounding unit is a speaker.

3. The wireless earphone as claimed in claim 1, wherein said lower case is covered with a protective casing.

4. The wireless earphone as claimed in claim 1, wherein said circuit unit has at least one terminal upward projected from a terminal hole provided on said upper case.

5. The wireless earphone as claimed in claim 1, wherein said guiding unit includes:
a pair of guiding shafts, on each of which an elastic element is mounted; and
a sliding element being provided at a lower front end with a first retaining recess, and at a rear top with a second retaining recess; said sliding element further having two ear portions sideward extended from two lateral sides of said sliding element, and each of said ear portions having a shaft hole; and said guiding shafts being extended through said shaft holes on said ear portions of said sliding element with said elastic elements located behind and compressed by said sliding element, and then being mounted in said first recess on the top of said upper case.

6. The wireless earphone as claimed in claim 5, wherein said sliding unit includes:
a seat having a first hook adapted to hook to said second recess at the rear top of said sliding element of said guiding unit; and said seat being provided in front of said first hook with a first hole for a second hook to mount therein and hook to said first retaining recess at the lower front end of said sliding element of said guiding unit;
a circuit board being mounted on said seat; and
a cover being connected to a top of said seat and provided at a predetermined position with a button hole for a push button to mount therein.

7. The wireless earphone as claimed in claim 6, wherein said second hook includes a front rod, around which an elastic element is mounted to normally push said second hook against said first retaining recess of said sliding element.

8. The wireless earphone as claimed in claim 6, wherein said upper case is provided with a second hole for a third hook to mount therein; said third hook having a lower end with an elastic element mounted thereon, and an upper end in contact with said push button mounted on said cover of said sliding unit.

9. The wireless earphone as claimed in claim 8, wherein said third hook is normally pushed upward by said elastic element mounted on the lower end thereof to project from said second hole of said upper case to hook to a retaining section on said seat of said sliding unit.

10. The wireless earphone as claimed in claim 1, wherein said lower case is provided with a plurality of small holes.

11. The wireless earphone as claimed in claim 6, wherein said circuit board of said sliding unit has a sound receiving element provided thereon.

12. The wireless earphone as claimed in claim 11, wherein said sound receiving element is a microphone.

13. The wireless earphone as claimed in claim 1 , wherein said sliding unit is slidably moved along a pair of guiding shafts of said guiding unit to a position projected from a front end of said upper case, and includes a circuit board having an electric terminal; and wherein said circuit unit includes at least one terminal upward projected from said upper case; and said at least one terminal on said circuit unit being electrically connected to said electric terminal on said circuit board of said sliding unit when said sliding unit is slid to said position projected from the front end of said upper case.
